(19) United States
(12) Patent Application Publication
(10) Pub. No.: US 2016/0084305 A1
(43) Pub. Date: Mar. 24, 2016

(54) ASSEMBLY HAVING GROOVE

(71) Applicant: Saint-Gobain Performance Plastics Corporation, Aurora, OH (US)

(72) Inventor: Munehiro Fujita, Shiojiri-shi (JP)

(21) Appl. No.: 14/862,935

(22) Filed: Sep. 23, 2015

(30) Foreign Application Priority Data
Sep. 23, 2014 (CN) 201420550203.3

(51) Int. Cl. F16C 33/10

(52) U.S. Cl. CPC F16C 33/102

(57) ABSTRACT

An assembly including an outer component defining a bore, an inner component disposed in the bore, and a tolerance ring disposed between the outer component and the inner component. The tolerance ring can include a sidewall and a plurality of projections extending radially outward from the sidewall. The outer component can define a groove containing a lubricant, wherein the groove extends circumferentially around the outer component, and wherein the groove axially aligns with at least one of the plurality of projections.

### CROSS-REFERENCE TO RELATED APPLICATION

This application claims priority under 35 U.S.C. §119(b) to Chinese Patent Application No. 201420550203.3 entitled “ASSEMBLY HAVING GROOVE,” by Munehiro Fujita, filed September 23, 2014.

### FIELD OF THE DISCLOSURE

The present disclosure relates to assemblies, and more particularly to assemblies having a grooved shaft and/or housing.

### RELATED ART

A tolerance ring may be disposed in a radial gap formed between an inner component, e.g., a shaft, and an outer component, e.g., a bore formed in a housing. The tolerance ring can act as a force limiter, permitting torque transfer between the inner and outer components. The use of a tolerance ring can accommodate variations in the diameter of the inner and outer components while maintaining interconnection therebetween.

Typically, a tolerance ring comprises a band of resilient material, e.g. a metal such as spring steel, the ends of which are brought towards one another to form an annular ring. Although tolerance rings usually comprise a strip of resilient material that is curved to allow the easy formation of a ring, a tolerance ring may also be manufactured as an annular band. Projections are typically stamped into the band of resilient material. The projections can span the radial gap between the inner and outer component and transmit forces therebetween.

Torque performance of lubricated assemblies typically declines rapidly upon lubricant exhaustion. This decline may result in unstable operation of the assembly and potentially damage on the shaft or housing.

There continues to exist a need for improved assemblies for use with tolerance rings.

### BRIEF DESCRIPTION OF THE DRAWINGS

Embodiments are illustrated by way of example and are not limited in the accompanying figures.

FIG. 1 includes a cross-sectional view of an assembly in accordance with an embodiment.

FIG. 2 includes a cross-sectional view of an assembly in accordance with another embodiment.

FIG. 3 includes a cross-sectional view of an assembly in accordance with another embodiment.

FIG. 4 includes a cross-sectional view of an outer component in accordance with an embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the tolerance ring, linear motion, and reciprocal motion arts.

Assemblies in accordance with embodiments described herein can generally include an inner component, an outer component, and a tolerance ring disposed therebetween. At least one of the inner and outer components can include a groove adapted to store a lubricant, such as grease, to promote a low friction slip interface between that component and the tolerance ring. In an embodiment, the tolerance ring can include a plurality of projections extending radially from a sidewall. In certain assemblies, the projections can extend radially outward from the sidewall. In such case, the groove can be disposed on an inner surface of the outer component such that the groove aligns with the projections. In other assemblies, the projections can extend radially inward from the sidewall. The groove can be disposed on an outer surface of the inner component, aligning with the projections.

In certain applications the inner component can move longitudinally with respect to the outer component (i.e., reciprocate). In other applications the inner component can rotate with respect to the outer component. Lubricant disposed within the groove can be pulled from the groove over prolonged relative movement between the inner and outer components. That is, lubricant can escape the groove, to facilitate a suitable low friction interface between the tolerance ring and the inner or outer component. In an embodiment, the lubricant can have a slow release characteristic such that only a small volume of lubricant is removed from groove with each passing relative motion between the inner and outer components (e.g., one reciprocal cycle or one full rotation). For example, the lubricant may disperse as little as 0.0001 mm² per motion. In another embodiment, the lubricant can be non-uniformly released from the groove. For example, release of lubricant during an initial motion can be higher than the release during subsequent motions. Thus, lubricant dispensing can decrease once the slip interface is sufficiently lubricated for a suitable sliding characteristic.

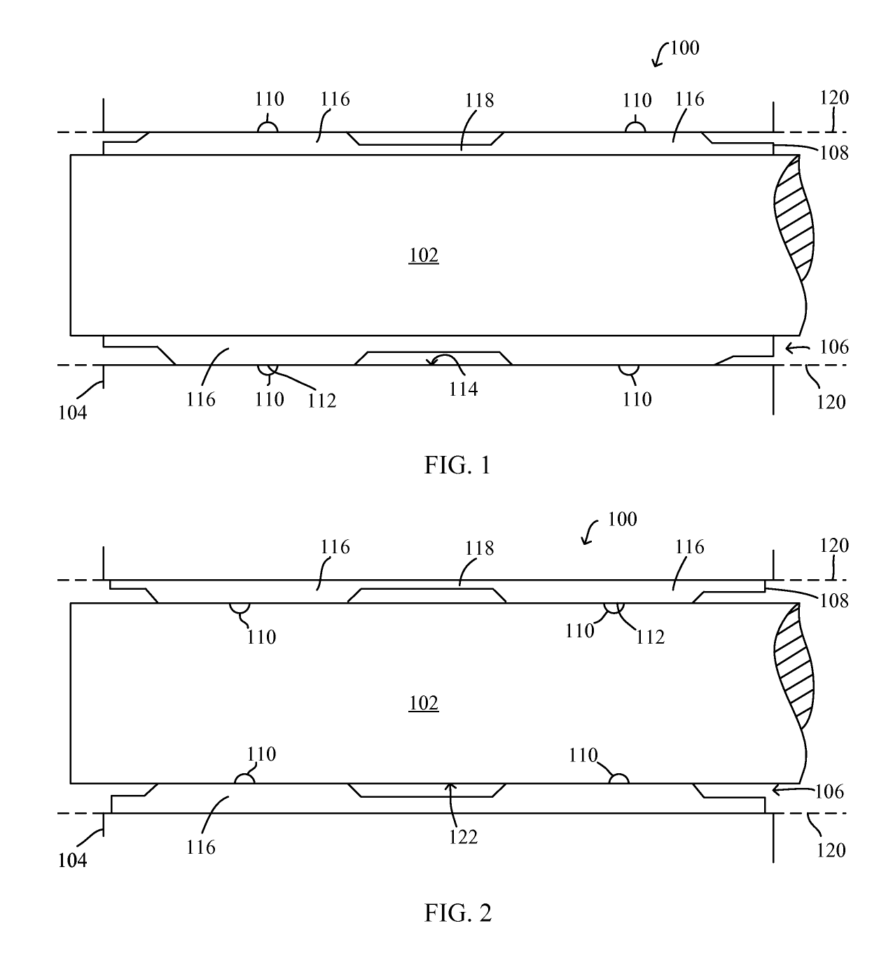

FIG. 1 illustrates an assembly 100 in accordance with an embodiment. Generally, the assembly 100 can include an inner component 102, e.g., a shaft, an outer component 104, e.g., a housing, defining a bore 106, and a tolerance ring 108 disposed between the inner and outer components 102 and 104.

In a particular instance, the inner component can 102 be generally cylindrical. As used herein, “generally cylindrical” refers to a condition whereby a component deviates from a best fit cylinder by no greater than 5% at any location, no greater than 4% at any location, no greater than 3% at any location, or no greater than 2% at any location. In another instance, the inner component 102 can be cylindrical. As used herein, “cylindrical” refers to a condition whereby a component deviates from a best fit cylinder by no greater than 1% at any location. Likewise, in an embodiment, the bore 106 of the outer component 104 can define an inner surface 114 having a generally cylindrical, or cylindrical, shape.

One or both of the inner and outer components 102 and 104 can further include a groove 110 containing, or adapted to contain, a lubricant 112. In an embodiment, the lubricant 112 includes a semisolid material having a high initial viscosity. The lubricant 112 may include an oil or similar fluid lubricant mixed with a thickening agent to form a pseudo-plastic fluid. Exemplary thickening agents include calcium, sodium, and lithium stearates.

In an embodiment, the lubricant 112 can include a grease. The grease may include a mineral-based oil, an asphaltic-type oil blend, an extreme-pressure grease, a roll-neck grease, soap thickened mineral oils, or a multi-purpose grease.

The lubricant 112 can further include an additive, such as molybdenum disulfide, tungsten disulfide, graphite, grapheme, expanded graphite, boron nitrade, talc, calcium fluoride, or any combination thereof. Additionally, the lubricant 112 can comprise alumina, silica, titanium dioxide, calcium fluoride, boron nitride, mica, Wollastonite, silicon carbide, silicon nitride, zirconia, carbon black, pigments, or any combination thereof. As illustrated in FIG. 1, the groove 110 can extend into the outer component 104 from the bore 106. In a particular embodiment, the groove 110 can extend circumferentially around the outer component 104. More particularly, the groove 110 can form an annular recess in the inner surface 114 of the outer component 104.

In certain embodiments, the groove 110 can have a generally polygonal cross section. That is, when viewed in cross section, the groove 110 can be formed from straight, or generally straight, surfaces interconnected at relative angles. In an exemplary embodiment, the groove 110 can include two sidewalls and a base extending between the two sidewalls. The base can extend perpendicular to at least one of the two sidewalls. In a more particular embodiment, the groove 110 can define a generally rectangular shape, such as a square. In another particular embodiment, the groove 110 can have a width as measured at the base that is different than the width as measured opposite the base, near the opening of the groove 110. In a particular embodiment, the width of the groove 110 at the base can be greater than the width of the groove 110 at the opening. In another embodiment, the width of the groove 110 at the base can be less than the width of the groove 110 at the opening. The sidewalls may extend linearly between the base and opening. Different shaped groove profiles can alter the flow of lubricant from the groove 110, increasing or decreasing the speed of lubricant dispersal.

In particular embodiments, the groove 110 can have one or more arcuate surfaces when viewed in cross section. For example, the groove 110 may include two linear sidewalls and an arcuate base surface extending between the sidewalls. In a particular embodiment, the arcuate base can define a greatest depth of the groove 110 at a middle, or generally middle, position therealong. In another particular embodiment, the arcuate base can have a greatest depth at positions adjacent to one or both of the linear sidewalls. In another embodiment, the groove 110 can be generally hemi-circular, i.e., a continuous, or generally continuous, arcuate surface. Alternatively, the base of the groove 110 may be hemi-circular, connecting with two linear or arcuate sidewalls which extend to the opening. In a particular embodiment, the groove 110 can have tapered side surfaces such that the groove 110 forms a parabolic shape. In an embodiment, at least one of the edges of the groove 110 may be rounded or tapered to promote lubricant 112 dispersal. In another embodiment, at least one of the edges can form a right angle. Castellations, undulations, or otherwise varying edges of the groove 110 may promote uneven dispersal of lubricant 112 from the groove 110. Such features may promote dispersal of lubricant 112 from certain zones of the groove 110, while other zones of the groove 110 can prevent dispersal of lubricant 112.

In an embodiment, the cross-sectional profile of the groove 110 can be uniform as measured around the circumference of the assembly 100. In another embodiment, the cross-sectional profile of the groove 110 can vary as measured around the circumference. In an embodiment, the groove 110 can have a first depth at a first location and a second depth at a second location, where the second depth is different (e.g., greater) from the first depth. Alternatively, the first location of the groove 110 can have an arcuate cross-sectional profile while the second location has a generally polygonal cross-sectional profile. In a particular instance, a uniform cross-sectional profile can promote even lubricant 112 dispersal. To the contrary, a varying profile may promote greater dispersal of lubricant 112 at desired locations while minimizing dispersal at those locations which do not require additional lubricant 112. In certain applications, it may be desirable for uneven dispersal. For example, certain assemblies have increased loading conditions along a particular surface or side of the assembly. That is, the frictional resistance to motion is greater at certain areas of the assembly. In such locations, the groove 110 can be shaped to more readily disperse lubricant 112, while the other locations may be shaped to retain lubricant.

Surface features within the groove 110 may enhance lubricant dispersal and provide pumping of lubricant 112 within the groove 110. The surface features can include, for example, ridges, undulations, dimples, bumps, wedges, other suitable features, and combinations thereof. In an embodiment, the surface features may enhance lubricant dispersal. In another embodiment, the surface features can reduce dispersal rates. Thus, the surface features can be disposed in the groove 110 in a suitable arrangement to obtain desired lubricant dispersal.

Slight variations or imperfections may occur in the groove 110 profile during formation. For example, ablation marks, cut lines, fouling, and other artifacts of formation may occur along the groove 110. Such variations and imperfections are generally acceptable given their size remains small. In particular embodiments, the groove 110 can be operated on to reduce the formation of the variations and imperfection. For example, the groove 110 may be sanded, blasted, ablated, chemically etched, scraped, or otherwise refined to remove the variations and imperfections.

The tolerance ring 108 can include a plurality of projections 116 extending radially from a sidewall 118. As illustrated the projections 116 can extend radially outward from the sidewall 118.

In an embodiment, the projections 116 may be press formed, e.g., stamped, into the sidewall 118. Each projection 116 can have substantially the same shape and size to permit even radial compression around the circumference of the tolerance ring 108. Alternatively, at least two projections 116 may be dissimilar from one another such that at least one attribute of the projections 116 is different. For example, a first projection can have a length that is at least 101% a length of a second projection, the radial height of the first projection can be different from the second projection, the circumferential width of the first projection can be different from the second projection, the surface roughness of the first projection can be different from the second projection, the first projection may include an opening or disconnected feature different from the second projection, or any combination thereof. Skilled artisans will recognize that the differences between projections 116 on the tolerance ring 108 are not limited to those exemplary embodiments described above and that projections 116 can have many different properties different from one another.

In a particular embodiment, at least one of the projections 116 can have an arcuate cross-sectional profile defining an outer apex. The projections116 can each include first and second axial ends spaced apart by a length and first and second longitudinal sides spaced apart by a width. In an embodiment, the length of the projections 116 can be greater than the width. For example, the length can be at least 101% the width, at least 110% the width, at least 125% the width, at least 150% the width, at least 200% the width, or at least 500% the width. In an embodiment, the length can be no greater than 10,000% the width.

In an embodiment, the tolerance ring 108 can include a resilient material, such as a metal, alloy, or polymer. The tolerance ring 108 can include a Vickers pyramid number hardness, VPN, which can be no less than 200, no less than 300, or no less than 400. In an embodiment, the VPN can be no greater than 600, or no greater than 500. In a particular embodiment, the tolerance ring 108 can include a material having a VPN hardness, VPN_{TR}, that is less than the VPN hardness of the inner or outer component VPN_{C}. As a result, the tolerance ring 108 will not embed into either of the inner or outer components 102 or 104 upon assembly.

In operation, the projections 116 are adapted to compress radially toward the sidewall 118. This permits the tolerance ring 108 to compensate for radial imperfections in the diameter of the inner and outer components 102 and 104 while simultaneously providing a slip interface therebetween.

In an embodiment, the projections 116 can all be disposed along a single circumferentially extending row such that both axial ends of all projections 116 align with one another. In another embodiment, for example, as illustrated in FIG. 1, the projections 116 can extend along at least two circumferentially extending rows. The circumferentially extending rows can be spaced apart from one another. In a particular instance, a circumferentially extending band of sidewall 118 can extend around the entire circumference of the tolerance ring 108 between the rows of projections 116. In yet a further embodiment, the projections 116 can be arranged into at least three circumferentially extending rows, at least four circumferentially extending rows, or at least five circumferentially extending rows. In a particular instance, the circumferentially extending rows of projections 116 can align such that one projection from each circumferentially extending row lies along a straight line parallel to a central axis of the tolerance ring 108. In another instance, at least one of the circumferentially extending rows of projections 116 can be angularly offset such a line extending parallel to the central axis of the tolerance ring and intersecting a projection of an adjacent row of projections does not intersect a projection on the at least one circumferentially extending row of projections 116.

In an embodiment, at least one projection 116 can align with the groove 110 so as to overlap the groove 110 in at least one position of movement. That is, the projection 116 radially overlaps the groove 110 at one or more times during a cycle of movement. In a further embodiment, all of the projections 116 can align with a corresponding groove 110. In such a manner, each groove 110 can provide lubricant 112 to the inner surface 114 of the outer component 104 along a slip interface 120 formed between the projections 116 of the tolerance ring 108 and the outer component 104.

In an embodiment, the assembly 100 can include a plurality of grooves 110. For example, the assembly 100 can include at least two grooves, at least three grooves, at least four grooves, at least five grooves, or even at least ten grooves. In an embodiment, the assembly 100 can include no greater than 10,000 grooves, no greater than 1,000 grooves, or no greater than 100 grooves. In a particular embodiment, the grooves can all have the same shape, size, and features. Further, the grooves 110 can all extend around the entire circumference of the outer component 104. In another embodiment, at least two of the grooves 110 can have a different shape, size, or feature. That is, at least two of the grooves 110 can be different from one another. For example, a first groove may extend continuously around an entire circumference of the outer component 104 while a second groove may extend in disconnected segments around the circumference of the outer component 104. While the first groove may provide uniform lubrication to the slip interface 120, the second groove can selectively lubricate particular locations along the slip interface 120.

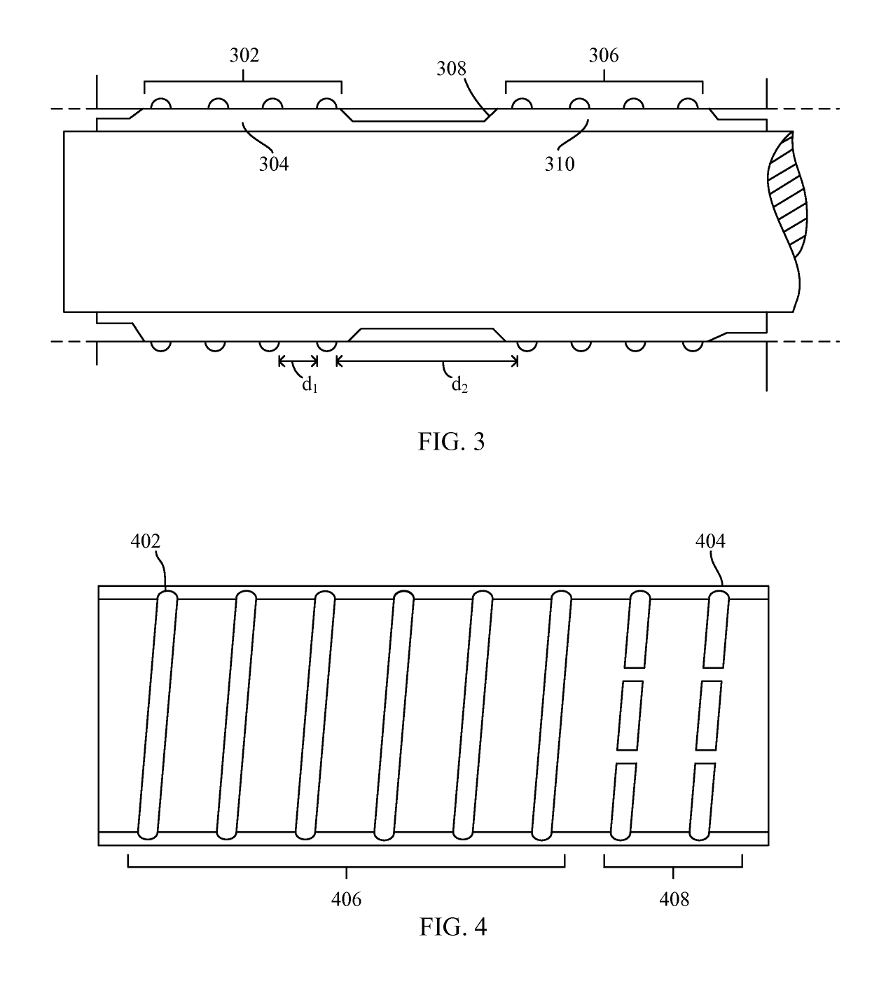

In a particular instance, the grooves 110 can be arranged along the outer component 104 such that a bank of grooves is disposed adjacent to the projections 116 of the tolerance ring 108. That is, an axial distance between adjacent grooves near the projections 116 can be less than a distance between grooves adjacent to the sidewall 118 between adjacent rows of circumferentially extending projections 116. For example, referring to FIG. 3, a first bank of grooves 302 can be disposed at a location adjacent to a first row of projections 304 of the tolerance ring 308. A second bank of grooves 306 can be disposed at a location adjacent to a second row of projections 310 of the tolerance ring 308. A distance, d₁, between adjacent grooves in the first bank of grooves 302 can be less than a distance, d₂, between the first and second bank of grooves 302 and 306. For example, d₁ can be less than 0.99 d₂, less than 0.8 d₂, less than 0.75 d₂, or less than 0.5 d₂. In another embodiment, d₁ can be no less than 0.05 d₂, or no less than 0.25 d₂. In an embodiment, the distance, d₁, between adjacent grooves of the same bank of grooves (e.g., bank 302 or 306) can be at least 0.1 mm, at least 1 mm, at least 10 mm, or at least 100 mm. The distance, d₂, between adjacent banks of grooves can be at least 10 mm, at least 100 mm, at least 1000 mm, or at least 10,000 mm.

In an aspect, the groove 110 may extend around the entire circumference of the inner or outer component 102 or 104. The groove 110 may be continuous and have a uniform profile as measured around the entire circumference. Uniformity of the groove profile may enhance operation by mitigating unevenness in lubrication along the assembly which might otherwise occur.

In an embodiment, each projection 116 can be disposed in the assembly 100 so as to contact at least one groove, at least two grooves, at least three grooves, or even at least four grooves. Grooves 110 disposed along the slip interface 120 may facilitate disbursement of lubricant 112 from the groove 110 to the slip interface 120 in a repeatable manner for at least two distinct relative movements between the inner and outer components 102 and 104, such as for at least three distinct relative movements, at least four distinct relative movements, at least five distinct relative movements, at least ten distinct relative movements, or even at least one hundred distinct relative movements. As used herein, each “distinct relative movement” refers to a slip condition between the inner and outer components 102 and 104, causing the components to relatively translate rotationally or axially. The dispersal of lubricant 112 can maintain the slip interface 120 at a fixed sliding characteristic. That is, each distinct relative movement can exhibit the same sliding characteristics. Whereas traditional assemblies might exhaust lubricant after only a few distinct relative movements between an inner and outer component thereby causing the slip interface 120 profile to change, assemblies 100 in accordance with embodiments herein can maintain a lubricated slip interface 120 by permitting a continuous, or desired, release of lubricant during operation. Thus, the assemblies 100 have a greater operational life span and may be used without adjustment for greater periods of time. Further, less maintenance and lubrication may be required to keep the assembly operational.

In an embodiment, the groove can have a generally helical shape. The helically-shaped groove can extend continuously along the assembly or appear as a collection of grooved segments spaced apart from one another in a generally helical arrangement. FIG. 4 illustrates a helically-shaped groove 402 extending along an outer component 404. The groove 402 may be continuous, such as illustrated along portion 406, disconnected, such as illustrated along portion 408, or include a combination of continuous and disconnected portions.

In a particular instance, as illustrated in FIG. 2, the groove 110 can extend into the inner component 102. In such a manner, the groove 110 can form a radial recess in an outer surface 122 of the inner component 102. Repositioning the groove 110 to the inner component 102 can provide similar slip characteristics to the embodiments as described above. The projections 116 of the tolerance ring 108 can extend radially inward so as to form a slip interface 120 along the junction between the tolerance ring 108 and the inner component 102. In such a manner, disbursement of the lubricant 112 from the groove 110 to the slip interface 120 may occur in a repeatable manner, e.g., for at least two distinct relative movements, such as for at least three distinct relative movements, at least four distinct relative movements, at least five distinct relative movements, or even at least ten distinct relative movements. One of ordinary skill will understand that embodiments as described above can enhance repeatable sliding characteristics between an inner component 102, a tolerance ring 108, and an outer component 104. Moreover, positioning of the lubricant along at least one of the inner and outer components 102 and 104 can allow for use of a traditional tolerance ring, e.g., a tolerance ring devoid of lubrication containing pockets or materials.

Regardless of configuration (grooves on the outer component in FIG. 1 or grooves on the inner component in FIG. 2), in an embodiment, assembly may occur upon insertion of lubricant into the groove. The lubricant may fill the entire volume defined by the groove. In an embodiment, lubricant can be pressed or packed into the groove. Additional lubricant can be left along the slip interface to facilitate initial movement of the assembly and to permit installation of the tolerance ring. A preassembly can be formed when the tolerance ring is fitted around the other of the inner and outer components (i.e., the component not including the groove) with the sidewall facing that component. The preassembly is then installed relative to the component including the groove and aligned to a final position.

In another embodiment, the tolerance ring can be fitted first to the component including the grooves. The projections of the tolerance ring can be oriented toward the grooves such that the sidewall is exposed. The other component (not including the grooves) may then be installed relative to the sidewall of the tolerance ring to form the assembly. It is noted that such assembly may be difficult absent further lubricant or sliding component disposed along the sidewall of the tolerance ring. In a particular embodiment, the sliding component can include a low friction layer attached to the tolerance ring. For example, the sliding component can include a low friction layer laminated to the sidewall. The low friction layer can include a low friction material, such as a low friction polymer (e.g., PTFE).

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1. An assembly comprising:

an outer component defining a bore;

an inner component disposed in the bore; and

a tolerance ring disposed between the outer component and the inner component, the tolerance ring including a sidewall and a plurality of projections extending radially outward from the sidewall,

wherein the outer component defines a groove containing a lubricant, wherein the groove extends circumferentially around the outer component, and wherein the groove axially aligns with at least one of the plurality of projections.

Embodiment 2. An assembly comprising:

an outer component defining a bore;

an inner component disposed in the bore; and

a tolerance ring disposed between the outer component and the inner component, the tolerance ring including a sidewall and a plurality of projections extending radially inward from the sidewall,

wherein the inner component defines a groove containing a lubricant, wherein the groove extends circumferentially around the inner component, and wherein the groove axially aligns with at least one of the plurality of projections.

Embodiment 3. An inner component for an assembly comprising:

a generally cylindrical body defining an outer surface;

a groove extending into the generally cylindrical body from the outer surface; and

a lubricant disposed in the groove,

wherein the groove is adapted to align with projections of a tolerance ring, and wherein the groove is adapted to disperse lubricant during sliding between the tolerance ring and the inner component.

Embodiment 4. An outer component for an assembly comprising:

a body defining a bore having an inner surface;

a groove extending into the body from the inner surface;

a lubricant disposed in the groove,

wherein the groove is adapted to align with projections of a tolerance ring, and wherein the groove is adapted to disperse lubricant during sliding between the tolerance ring and the inner component.

Embodiment 5. A preassembly comprising:

an outer component defining a bore having an inner surface;

an inner component defining an outer surface and disposed within the bore;

a groove extending into at least one of the inner and outer components; and

a lubricant disposed in the groove,

wherein the groove is adapted to align with projections of a tolerance ring, and wherein the groove is adapted to disperse lubricant during sliding between the tolerance ring and the inner component.

Embodiment 6. The assembly, preassembly, or component of any one of the preceding embodiments, wherein an interface formed between the plurality of projections and the tolerance ring defines a slip interface.

Embodiment 7. The assembly, preassembly, or component of embodiment 3, wherein, upon relative movement at the slip interface, a portion of the lubricant is dispersed from the groove to the slip interface.

Embodiment 8. The assembly, preassembly, or component of embodiment 4, wherein disbursement of the lubricant from the groove to the slip interface is repeatable for at least two distinct relative movements between the inner and outer components.

Embodiment 9. The assembly, preassembly, or component of any one of the preceding embodiments, wherein the groove includes a plurality of grooves.

Embodiment 10. The assembly, preassembly, or component of any one of the preceding embodiments, wherein the groove defines an annular recess.

Embodiment 11. The assembly, preassembly, or component of any one of the preceding embodiments, wherein the groove is helical.

Embodiment 12. The assembly, preassembly, or component of any one of the preceding embodiments, wherein each of the plurality of projections extends in a direction perpendicular to the groove.

Embodiment 13. The assembly, preassembly, or component of any one of the preceding embodiments, wherein the lubricant includes a grease.

Embodiment 14. The assembly, preassembly, or component of any one of the preceding embodiments, wherein the tolerance ring comprises a circumferentially extending rim along at least one axial end of the projections.

Embodiment 15. The assembly, preassembly, or component of any one of the preceding embodiments, wherein the tolerance ring comprises a sidewall and a plurality of projections extending radially from the sidewall.

Embodiment 16. The assembly, preassembly, or component of any one of the preceding embodiments, wherein the groove has a polygonal cross-sectional profile, wherein the groove has an arcuate cross-sectional profile.

Embodiment 17. The assembly, preassembly, or component of any one of the preceding embodiments, wherein the groove has a generally U-shaped cross section.

Embodiment 18. The assembly, preassembly, or component of any one of the preceding embodiments, wherein the groove extends entirely around a circumference of the inner or outer component.

Embodiment 19. The assembly, preassembly, or component of any one of the preceding embodiments, wherein the tolerance ring comprises a number, n, of circumferentially extending rows of projections, wherein the groove comprises n grooves, and wherein each of the n grooves is aligned with a circumferentially extending row of projections.

Embodiment 20. The assembly, preassembly, or component of any one of the preceding embodiments, wherein the groove extends into the inner or outer component at least 1 mm, at least 2 mm, at least 3 mm, at least 4 mm, at least 5 mm, at least 10 mm, or at least 25 mm.

Embodiment 21. The assembly, preassembly, or component of any one of the preceding embodiments, wherein the groove extends into the inner or outer component no greater than 100 mm, no greater than 75 mm, or no greater than 50 mm.

Embodiment 22. The assembly, preassembly, or component of any one of the preceding embodiments, wherein the tolerance ring comprises a low friction layer, and wherein the low friction layer is coupled to at least one of the sidewall and projections.

Embodiment 23. The assembly or preassembly of any one of embodiments 1, 2, or 5 to 21, wherein the inner component is adapted to rotate relative to the outer component, wherein the inner component is adapted to reciprocate with respect to the outer component, or a combination thereof.

Embodiment 24. The assembly, preassembly, or component of any one of the preceding embodiments, wherein the assembly comprises a steering column assembly.

Note that not all of the features described above are required, that a portion of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

1. An assembly comprising:
an outer component defining a bore;
an inner component disposed in the bore; and
a tolerance ring disposed between the outer component and the inner component, the tolerance ring including a sidewall and a plurality of projections extending radially outward from the sidewall,
wherein the outer component defines a groove containing a lubricant, wherein the groove extends circumferentially around the outer component, and wherein the groove axially aligns with at least one of the plurality of projections.

2. The assembly of claim 1, wherein an interface formed between the plurality of projections and the tolerance ring defines a slip interface, and wherein, upon relative movement at the slip interface, a portion of the lubricant is dispersed from the groove to the slip interface.

3. The assembly of claim 1, wherein each of the plurality of projections extends in a direction perpendicular to the groove.

4. The assembly of claim 1, wherein the groove extends entirely around a circumference of the outer component.

5. The assembly of claim 1, wherein the tolerance ring comprises a number, n, of circumferentially extending rows of projections, wherein the groove comprises n grooves, and wherein each of the n grooves is aligned with a circumferentially extending row of projections.

6. The assembly of claim 1, wherein the inner component is adapted to reciprocate with respect to the outer component.

7. The assembly of claim 1, wherein the assembly comprises a steering column assembly.

8. An assembly comprising:
an outer component defining a bore;
an inner component disposed in the bore; and
a tolerance ring disposed between the outer component and the inner component, the tolerance ring including a sidewall and a plurality of projections extending radially inward from the sidewall,
wherein the inner component defines a groove containing a lubricant, wherein the groove extends circumferentially around the inner component, and wherein the groove axially aligns with at least one of the plurality of projections.

9. The assembly of claim 8, wherein an interface formed between the plurality of projections and the tolerance ring defines a slip interface, and wherein, upon relative movement at the slip interface, a portion of the lubricant is dispersed from the groove to the slip interface.

10. The assembly of claim 8, wherein each of the plurality of projections extends in a direction perpendicular to the groove.

11. The assembly of claim 8, wherein the groove extends entirely around a circumference of the outer component.

12. The assembly of claim 8, wherein the tolerance ring comprises a number, n, of circumferentially extending rows of projections, wherein the groove comprises n grooves, and wherein each of the n grooves is aligned with a circumferentially extending row of projections.

13. The assembly of claim 8, wherein the tolerance ring comprises a circumferentially extending rim along at least one axial end of the projections.

14. The assembly of claim 8, wherein the groove has a generally U-shaped cross section.

15. The assembly of claim 8, wherein the tolerance ring comprises a low friction layer, and wherein the low friction layer.

16. The assembly of claim 8, wherein the groove includes a plurality of grooves.

17. A preassembly comprising:
an outer component defining a bore having an inner surface;
an inner component defining an outer surface and disposed within the bore;
a groove extending into at least one of the inner and outer components; and
a lubricant disposed in the groove,
wherein the groove is adapted to align with projections of a tolerance ring, and wherein the groove is adapted to disperse lubricant during sliding between the tolerance ring and the inner component.

18. The preassembly of claim 17, wherein an interface formed between the plurality of projections and the tolerance ring defines a slip interface, wherein, upon relative movement at the slip interface, a portion of the lubricant is dispersed from the groove to the slip interface, and wherein disbursement of the lubricant from the groove to the slip interface is repeatable for at least two distinct relative movements between the inner and outer components.

19. The preassembly of claim 18, wherein the groove has a generally U-shaped cross section, and wherein the groove extends entirely around a circumference of the inner or outer component.

20. The preassembly of claim 18, wherein the groove extends into the inner or outer component at least 1 mm.
